(19) United States
(12) Patent Application Publication
(10) Pub. No.: US 2007/0110931 A1
(43) Pub. Date: May 17, 2007

(54) Rod member

(76) Inventor: Ming-Tsai Tsai, Taichung County (TW)

Correspondence Address: BACON & THOMAS, PLLC, 625 SLATERS LANE, FOURTH FLOOR, ALEXANDRIA, VA, 22314, US

(21) Appl. No.: 11/327,498

(22) Filed: Jan. 9, 2006

(30) Foreign Application Priority Data
Nov. 17, 2005 (TW) 200520129098.7

(51) Int. Cl. B32B 27/10

(52) U.S. Cl. 428/34.2; 428/36.91

(57) ABSTRACT

A rod member includes a main body formed of a metal tube, a paper layer surrounding the main body, and a wooden covering surrounding the paper layer.

### BACKGROUND OF THE INVENTION

1. Field of the Invention

The present invention relates to rod members and more particularly, to a rod member having an outer wooden covering.

2. Description of the Related Art

Long wooden rod members are commonly used in home furniture, such as top rails for window coverings, for the advantage of a nice touch and good outer looking. However, moisture will make wooden rod members rot or curve. This is the major drawback of long wooden rod members.

### SUMMARY OF THE INVENTION

The present invention has been accomplished under the circumstances in view. It is therefore the main object of the present invention to provide a rod member, which eliminates the drawback of wooden rod members to be easy to rot when wet.

It is another object of the present invention to provide a rod member, which eliminates the drawback of wooden rod members to be easy to break.

To achieve these objects of the present invention, the rod member provided by the present invention comprises a main body, which is formed of an elongated metal tube, a paper layer, which surrounds the main body, and a wooden covering, which surrounds the paper layer.

### BRIEF DESCRIPTION OF THE DRAWINGS

FIG. 1 is a perspective view of a rod member according to a preferred embodiment of the present invention.

FIG. 2 is a sectional view taken along line 2-2 of FIG. 1.

FIG. 3 is a schematic drawing showing an application example of the present invention.

### DETAILED DESCRIPTION OF THE INVENTION

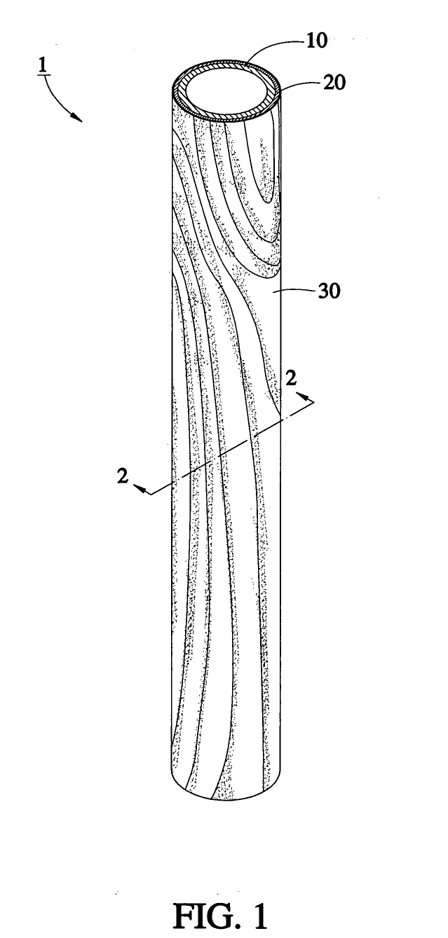

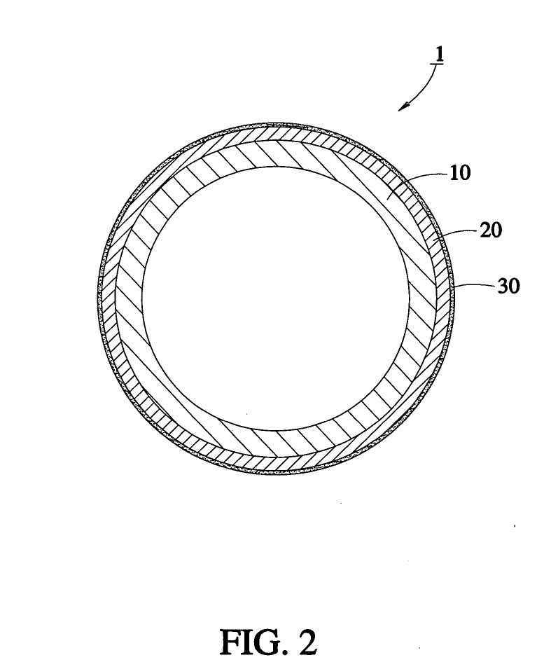

As shown in FIGS. 1 and 2, a rod member 1 in accordance with the present invention comprises a main body 10, which is formed of an elongated metal tube, a paper layer 20, which surrounds the main body 10, and a wooden covering 30, which surrounds the paper layer 30.

The paper layer 20 is wound round and fixedly adhered to the outer periphery of the main body 10, i.e., the paper layer 20 is a sheet of paper covered with a layer of glue on the back surface and then wound round the main body 10 through several runs. Alternatively, the paper layer 20 can be formed of a tube of paper, and then coated with a layer of glue on the inner diameter, and then tightly fitted onto the outer periphery of the main body 10.

Because the main body 10 and the wooden covering 30 are relatively harder, it is difficult to adhere the wooden covering 30 to the periphery of the main body 10 directly. However, the paper layer 20 is soft, and the particular fiber structure of the paper layer 20 is in favor the absorption of glue and can easily be adhered to the main body 10 and the wooden covering 30. Therefore, the paper layer 20 is used as an intermediate layer between the main body 10 and the wooden covering 30, keeping the wooden covering 30 firmly adhered to the main body 10. Further, the paper layer 20 is cheap.

Further, because the main body 10 and the wooden covering 30 are hard materials, directly bonding the wooden covering 30 to the main body 10 cannot make a rod member that has a soft touch. Therefore, the paper layer 20 is used and sandwiched in between the main body 10 and the wooden covering 30 to buffer the pressure employed to the wooden covering 30, providing a soft touch.

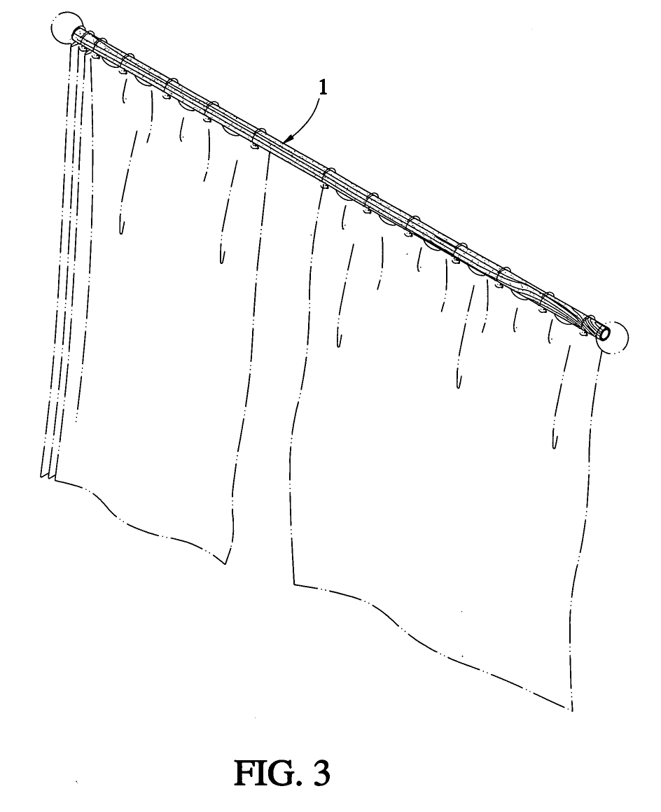

FIG. 3 shows an application example of the present invention. As illustrated, the rod member 1 is used to hold window coverings. Instead of conventional solid structure, the rod member 1 is based on the hollow tough main body 10. The outer wooden covering 30 causes a sense of beauty. The intermediate paper layer 20 enables the rod member 1 to give a soft touch.

As indicated above, the invention provides a rod member that has the following advantages:

1. Although the core of the rod member is formed of a metal tube, the stripes pattern of the outer wooden covering of the rod member gives a nice touch and good outer looking.

2. Because the core of the rod member is formed of a metal tube but not a solid wooden rod, it does not absorb the moisture in air. Therefore, the rod member of the present invention does not rot.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A rod member comprising:
a main body formed of an elongated tube;
a paper layer adhered to an outer periphery of said main body; and
a wooden covering surrounding said paper layer.

2. The rod member as claimed in claim 1, wherein said elongated tube is a metal tube.

3. The rod member as claimed in claim 1, wherein said paper layer is wound round and adhered to the outer periphery of said main body.

4. The rod member as claimed in claim 1, wherein said paper layer is formed of a tube of paper, said tube of paper having an inner diameter covered with a layer of a glue and tightly fitted onto the outer periphery of said main body.
